(19) United States
(12) Patent Application Publication
(10) Pub. No.: US 2006/0200496 A1
(43) Pub. Date: Sep. 7, 2006

(54) Organization action incidents

(75) Inventors: Lior Okman, Zoran (IL); Noam Rotem, Modiin (IL); Barak Ori, Givatayim (IL); Eyal Rubin, Holon (IL)

Correspondence Address: CARR & FERRELL LLP, 2200 GENG ROAD, PALO ALTO, CA, 94303, US

(73) Assignee: Transparency Software, Inc.

(21) Appl. No.: 11/359,288

(22) Filed: Feb. 21, 2006

Related U.S. Application Data
(60) Provisional application No. 60/655,347, filed on Feb. 22, 2005.
(60) Provisional application No. 60/655,611, filed on Feb. 22, 2005.
(60) Provisional application No. 60/707,838, filed on Aug. 11, 2005.

(51) Int. Cl. G06F 17/00

(52) U.S. Cl. 707/104.1

(57) ABSTRACT

A system for identifying and managing incidents of organization actions performed with applications includes a processor and communications interface. The communications interface receives communication messages between an application and a server. The processor receives at least one policy for an organization action performed with the application. The processor processes the communication messages between the application and the server to determine the organization action. The processor determines at least one metric related to the organization action based on the communications messages. The processor then determines whether the metric complies with the policy.

### CROSS-REFERENCE TO RELATED APPLICATION

This application claims the benefit of U.S. Provisional Application No. 60/655,347, filed Feb. 22, 2005 and entitled “System for Enhanced Database Analysis,” U.S. Provisional Application No. 60/655,611, filed Feb. 22, 2005 and entitled “Method for Enhanced Database Analysis,” and U.S. Provisional Application No. 60/707,838, filed Aug. 11, 2005 and entitled 'Database Analysis,” the subject matter of which are all hereby incorporated by reference.

This application is related to U.S. application Ser. No. 11/285,908, filed Nov. 22, 2005 and entitled “System and Method for Determining Information Related to User Interactions with an Application,” which is hereby incorporated by reference.

### BACKGROUND

1. Technical Field

The present invention relates generally to computer systems and more particularly to organization action incidents.

2. Description of Related Art

Online Transaction Processing (OLTP) is a form of transaction processing conducted via communication networks, such as the Internet. Some examples of OLTP include electronic banking, order processing, employee time clock systems, e-commerce, and e-trading. Users interact with OLTP applications to perform one or more activities (such as booking a flight or reserving a rental car) that serve well-defined purposes or goals in an organization. To fulfill the purposes or goals, the activities performed by the users also typically need to access and/or manipulate the organization's data in storage servers. Users interacting with the OLTP applications can access the storage servers to manipulate the organization's data and define the data structure.

An administrator in the organization typically monitors performance and security of the storage servers and maintains the integrity, availability, and recoverability of the organization's data. The administrator also ensures efficient and successful processing of transactions between the OLTP applications and the storage servers. To aid the administrator in performing his or her duties, numerous storage server tools have been developed. One example of a storage server tool is the Oracle Enterprise Manager for Oracle Databases by Oracle Corporation of Redwood Shores, Calif. The Oracle Enterprise Manager displays to the administrator (e.g., a database administrator) server instances, sessions, user privileges, and storage of an Oracle database server.

Additionally, the administrator generally uses the storage server tools to establish one or more rules or policies that determine how resources in the organization, such as the organization's data, are used and/or accessed. Typically, the rules or policies control usage, security, or performance of resources at the user and application levels. For example, one policy may control the time of day a user can log on to an OLTP application. However, one problem is that the tools are unable to establish policies for the activities that serve the well-defined purposes or goals in the organization, such as booking the flight or reserving the rental car.

One limitation of these tools is the inability to decipher business level transactions from the raw data. Storage server tools, such as the Oracle Enterprise Manager, generate copious amount of information sent between the OLTP applications and the storage servers, thus, making the use of this information extremely confusing. For example, in addition to server instances, sessions, user privileges, and storage of an Oracle datatbase server, the Oracle Enterprise Manager displays overwhelming amounts or raw data in the form of queries (e.g., Structure Query Language statements) sent to the Oracle database server. As the number of users interacting with OLTP applications increases, reports generated by the Oracle Enterprise Manager may contain hundreds of thousands of queries. The administrator cannot quickly identify problems, such as those that do not comply with a policy, form the raw data to troubleshoot security or performance issues between the OLTP applications and the storage servers.

### SUMMARY OF THE INVENTION

The invention addresses some of the above limitations by providing a system for managing incidents of organization actions performed with applications. The system includes a processor and a communications interface. The communications interface receives communication messages between an application and a server. The processor receives at least one policy for an organization action performed with the application. The processor processes the communication messages between the application and the server to determine the organization action. The processor determines at least one metric related to the organization action based on the communication messages. The processor then determines whether the metric complies with the policy.

In some embodiments, the processor determines a task to perform based on the determination whether the metric complies with the policy. The task may include setting a warning indicator for the organization action. The task may include generating a log of the determination of whether the metric complies with the policy. The policy may indicate an expected performance of the organization action with the application and the server. The policy may also indicate security privileges. The metric may include execution time for the organization action. Additionally, the processor may generate a report for display to an administrator based on the determination whether the metric complies with the policy.

The system advantageously allows the administrator to manage incidents of organization actions performed with applications based on various metrics, such performance, security, and compliance metrics related to the organization actions. Additionally, the system can identify for the administrator organization actions that do not comply with organization policy. Moreover, the administrator can quickly relate user reported problems to organization action incidents flagged by the system.

### BRIEF DESCRIPTION OF THE DRAWINGS

FIG. 1 is a block diagram of a system for determining interactions of users with an application in an exemplary implementation of the invention;

FIG. 2 is a flowchart for managing incidents of organization actions performed with applications in an exemplary implementation of the invention;

FIGS. 3A and 3B are a flowchart for managing incidents of organization actions performed with applications based on execution time in an exemplary implementation of the invention;

FIG. 4 depicts a screenshot of a business action incident viewer in an exemplary implementation of the invention;

FIG. 5 depicts a screenshot of a dashboard for business actions in an exemplary implementation of the invention;

FIG. 6 depicts a screenshot of details of a business action incident in an exemplary implementation of the invention;

FIG. 7 depicts a screenshot of a database event impact analysis in an exemplary implementation of the invention;

FIG. 8 depicts a screenshot of a business action locator in an exemplary implementation of the invention;

FIG. 9 depicts a screenshot of results of locating business actions in an exemplary implementation of the invention; and

FIG. 10 is an illustration of the collector and the analyzer in an exemplary implementation of the invention.

### DETAILED DESCRIPTION OF THE INVENTION

The embodiments discussed herein are illustrative of one example of the present invention. In order to better understand the present invention, aspects of the environment within which the invention operates will first be described. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

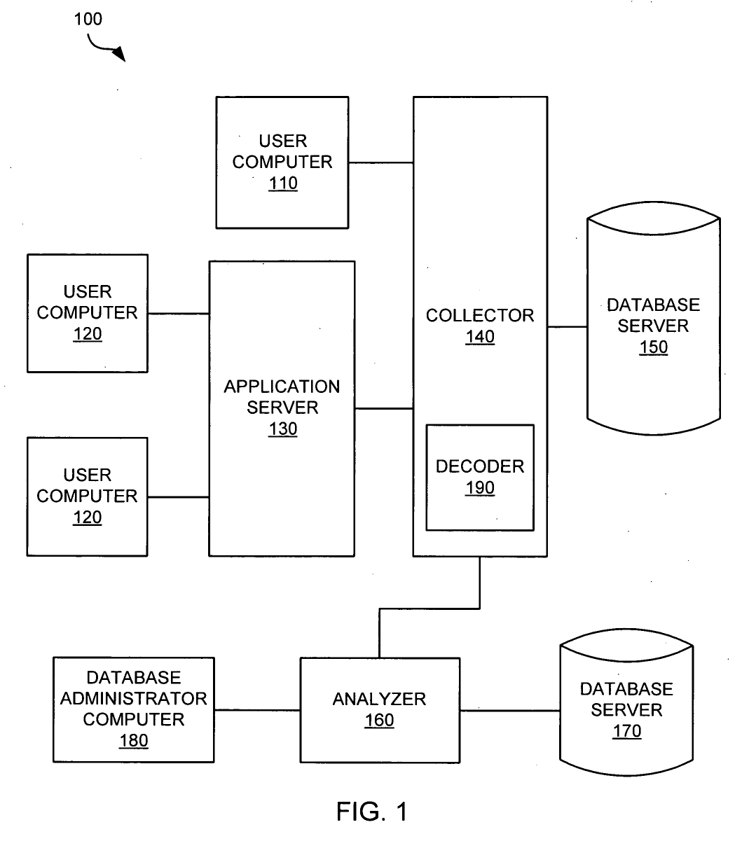

Determining Organization Actions Performed with Applications—FIG. 1

In general, a system for determining information related to user interactions with an application provides a bridge to monitor performance in a system where the application sends data to a server in response to the user interacting with the application. The system includes a collector, an analyzer, and a storage device. The collector inspects communication messages sent from applications to servers in response to users interacting with the applications. The analyzer determines or recognizes, based on the communication messages, organization actions performed by the users with the applications and the servers.

FIG. 1 is a block diagram of a system 100 for determining interactions of users with an application in an exemplary implementation of the invention. The system 100 includes a user computer 110, user computers 120, an application server 130, a collector 140, a database server 150, an analyzer 160, a database server 170, and a database administrator computer 180. The collector 140 includes a decoder 190.

The user computer 110 is linked to the collector 140. The user computers 120 are linked to the application server 130. One user computer 110 and two user computers 120 are shown for the sake of simplicity, although multiple user computers 110 and more than two user computers 120 may be included. The application server 130 is linked to the collector 140. Other embodiments may have multiple application servers 130 that are also linked to the collector 140. The collector 140 is linked to the database server 150 and the analyzer 160. The analyzer 160 is linked to the database server 170 and the database administrator computer 180.

Some examples of the user computers 110 and 120 and the database administrator computer 180 are general purpose computers. In one example, the user computer 110 comprises a personal computer (PC) that executes a software application for communicating with the database server 150 (e.g., by sending SQL queries to the database server 150 via the collector 140). In another example, the user computers 120 comprise PCs that execute applications for communicating with the database server 150 through the application server 130. In yet another example, the user computers 110 and 120 may comprise a first database server sending packets (e.g. packets containing one or more SQLs or other database language) to a second database server (e.g., the database server 150) via a database link mechanism. Alternatively, the user computers 110 and 120 and the database administrator computer 180 may comprise any workstations, mainframes, networked clients, and/or application servers. An administrator user, such as a database administrator for the database server 150, uses the database administrator computer 180 to monitor performance of the system 100. The administrator user may be a natural person or a computer program, job, or process.

The application server 130 comprises hardware and/or software elements that execute software applications. The application server 130 may accept input from another computer (e.g., the user computers 120). In this example, the application server 130 comprises a BEA WebLogic Server running a Medical Records Application. The Medical Records Application is configured to transmit SQL queries to a database server (e.g., the application server 130 may comprise a database client executed on the database server 150) on behalf of the user computers 120. Alternatively, the application server 130 may comprise an application executed on the server (e.g., the database server 150). The database server 150 comprises hardware and/or software elements that store data and provides access to the data. The database server 150 may store a collection of data in a systematic way such that a user interacting with a computer application (e.g., the application server 130) can consult the database server 150 to manipulate the data and define the data structure. One example of the database server 150 is an Oracle 9i Database application executed on a server running the Red Hat 2.1 Advanced Server operating system.

The collector 140 comprises hardware and/or software elements that inspect data sent from an application (e.g., the application server 130) to a server (e.g., the database server 150). Some examples of the data are server protocols (e.g., Transmission Control Protocol/Internet Protocol (TCP/IP) packets, Hypertext Transfer Protocol (HTTP) messages), Lightweight Directory Access Protocol (LDAP) requests and responses, Simple Object Access Protocol (SOAP) data, Internet Inter-ORB Protocol (IIOP) data, Structured Query Language (SQL) statements, and inter-process communications. An application is any program designed for end users that performs tasks and/or functions for the end-user, whether a natural person or another computer program, process, job, or service. Applications typically interact, call, or sit on top of system software and operating systems. Some examples of applications are word processors, web browsers, and database clients.

A server is any hardware and/or software elements that provides services through a communication network and may provide access to network resources. For example, a file server is a computer and storage device dedicated to storing files where a user on the network can store files on the file server. A server can also refer to the computer software program that is managing resources rather than the entire computer. Some examples of the server are database servers (e.g., Oracle, UDB/DB2, MySQL, IMS, Sybase, Microsoft SQL Server, as well as any other flat-file database, hierarchical database, and relational database), directory servers (e.g., Lightweight Directory Access Protocol (LDAP) servers), file servers, storage servers, message servers, and other application servers.

The collector 140 of this exemplary embodiment, for example, comprises a hardware database proxy server. The collector 140 receives data (e.g., queries) on behalf of the database server 150 and forwards the queries to the database server 150. Alternatively, the collector 140 may comprise a software proxy. For example, in one embodiment, the collector 140 comprises a software proxy running on the database server 150. In some embodiments, the collector 140 comprises a “sniffer” that sniffs the data from a communication network coupling the application server 130 and the database server 150. The collector 140 may be configured to sniff any client/server configuration. Alternatively, the collector 140 may inspect the data by inspecting memory activity of the server, inspecting inter-process communications, inspecting server processes, inspecting server logs, inspecting driver instrumentation activity for the server, inspecting protocol packets accessing the server, and inspecting other network levels.

Advantageously, the collector 140 may be embodied in hardware, software, and/or firmware to provide flexibility for integrating the collector 140 into existing hardware and software deployments. Additionally, the sniffing feature of the collector 140 provides transparency to the user computer 110 and the application server 130 during access to the database server 150. In some embodiments, the collector 140 includes the decoder 190. The decoder 190 comprises hardware and/or software elements that decode the data inspected by the collector 140. For example, the decoder 190 may decode the data comprising Oracle 9i Database Transparent Network Substrate (TNS) and Two-Task Common (TTC) data streams. The decoder 190 then may transmit the decoded data to the analyzer 160. In still other embodiments, the decoder 190 may be located outside of the collector 140. The decoder 190 may also be included in the analyzer 160.

The analyzer 160 comprises hardware and/or software elements that determine an “interaction” of a “user” with an application and a server. The analyzer 160 determines the interaction directly or indirectly based on data sent from the application to the server in response to the interaction of the user with the application.

A “user” may be a natural person and/or another computer application interacting with the application. For example, the user may be any service, job, process, and/or thread interacting with the application. In another example, the user may be a first database server sending packets to the application (e.g., a second database server) via a database link mechanism. An “interaction” of a user with an application comprises any activity, contact, interface, or task by the user with the application that directs the application to send data to the server. Some examples of interactions of users with applications are clicking a button, generating a report, logging on to the applications, and entering data into the applications.

In some embodiments, the analyzer 160 determines a “technical transaction.” A “technical transaction” is a sequence of one or more server protocol statements (e.g., SQL queries) and an end sequence indicator. An end sequence indicator comprises, for example, a “COMMIT” or “ROLLBACK” statement, cursor activity, a predefined delimiter, or a continuous number of seconds of idle connection time at the server. A technical transaction may include a sequence of commands that insert, delete, update, or retrieve data from an enterprise storage system (e.g., the database server 150). In another example, a technical transaction is an atomic operation where either a server approves the one or more server protocol statements and therefore performs the one or more protocol statements (Commit) or the server rejects the one or more server protocol statements (i.e. none of one or more server protocol statements are performed (Roll back)).

In some embodiments, the analyzer 160 determines a “business action” performed by the user. A “business action” is any step, function, or procedure for a business that an application performs in response to a user interaction with the application. Some examples of business actions are “user clicks,” “services,” “jobs,” or any type of event that causes the application to access the storage mechanism. A “user click” is any action (e.g., a mouse click or key press) of a user with a user interface device (e.g., a mouse or keyboard) on an interactive element (e.g., a button) in an application that causes the application to access a server. A user click business action may begin after the user click on the first interaction with the server and end on the last interaction with the server. A “service” is any request by a first application to a second application to provide a function (e.g., fraud detection or weather check). A service business action may begin after the service request and on the first interaction with the server and end on the last interaction with the server. A “job” is any function, routine, or procedure that is activated in a recurring fashion (e.g., by a job scheduler). A job business action may comprise interaction performed by the job from the job start to finish.

Some examples of business actions are a user click on a “Submit” button that approves a purchase made on an e-commerce site, a user click on a “Submit” button choosing a hotel to be reserved in a vacation reservation application, a service requested by another application to check fraud detection, and a report job executed on an hourly basis that issues a summary of new customers added to a system in the last hour. The analyzer 160 may determine business actions based on cursor activity, connection activity to a server (e.g., the database server 150), schema activities, and time indicators for the user, application, and/or the server, and one or more technical transactions.

In some embodiments, the analyzer 160 determines a “business scenario” between the user, the application, and the server. A business scenario comprises a sequence of user-application interactions. One example of a business scenario includes one or more business actions and a time indicator. The time indicator comprises, for example, the execution and/or idle time of the one or more business actions, the time the user takes between user interactions with the application, and/or the time that the server is idle (e.g., idle time for the database server 150). Another example of a business scenario is a “Vacation Reservation” which includes a sequence of business actions (e.g., “Reserve Flight→Confirm Flight Reservation→Reserve Hotel→Confirm Hotel Reservation→Reserve Car→Confirm Car Reservation→Proceed to checkout→Payment Mechanism→Approve Purchase Order”).

In one example of operation, the user computer 110 and the application server 130 send data to the database server 150 via the collector 140 to enable interactions of users (e.g., technical transactions, business actions, and/or business scenarios) with the user computers 1.10 and 120, the application server 130, and the database server 150. The collector 140 acts as a proxy to the database 150 and inspects the data sent to the database server 150.

The decoder 190 in the collector 140 converts the data (e.g., information inside packets or SQL queries) to a format understandable by the analyzer 160. The collector 140 then forwards the packets to the analyzer 160. The analyzer 160 determines the interactions of the users with the application (e.g., the application server 130) based on the packets. The analyzer 160 stores the interactions, including the packets, in the database server 170.

Advantageously, the collector 140, the analyzer 160, the database server 170, and the database administrator computer 180 may provide an administrator user a report or log of the interactions of users on the database administrator computer 180. The administrator user can quickly identify interactions of users that result in poor performance, unavailable resources, or errors in the database server 150.

Advantageously, the collector 140, the analyzer 160, the database server 170, and the database administrator computer 180 may generate a report containing the technical transactions and business actions of interactions of users with the application server 130 and the database server 150. The database administrator may adjust performance of the application server 130 and/or the database server 150 to prioritize one or more technical transactions and/or business actions. The database administrator can determine from the report that some user interactions with the application server 130 (i.e., execution of particular technical transactions and/or business actions) will deteriorate server performance and/or otherwise affect interactions of other users with the application server 130 and the database server 150. Additionally, if types of technical transactions and/or business actions should only be executed by particular users, the database administrator may quickly determine from the report whether executions or abuses have occurred by non-authorized users.

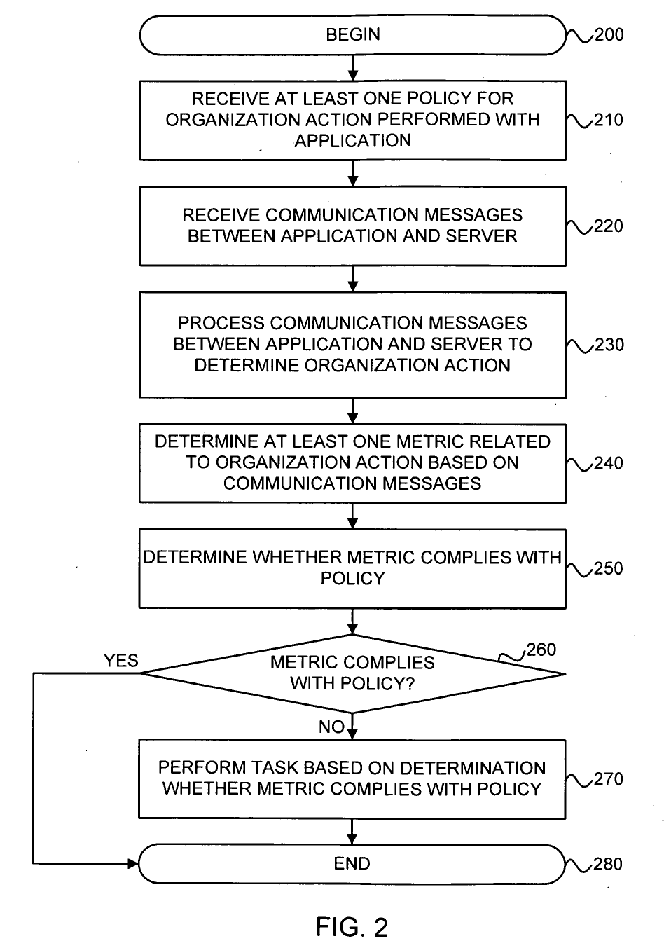

Organization Action Incident Analysis—FIGS. 2-10

In general, a system for identifying and managing incidents of organization actions performed with applications includes a processor and a communications interface. The communications interface receives communication messages between an application and a server. The processor receives at least one policy for an organization action performed within the application. The processor processes the communication messages between the application and the server to determine the organization action. The processor determines at least one metric related to the organization action based on the communication messages. The processor then determines whether the metric complies with the policy.

An organization action is any step, function, or procedure of an organization that an application performs in response to a user interaction with the application. One example of an organization action is a business action. An organization action incident is an organization action that is not executing as expected. The system allows metrics related to the organization actions to be compared to or evaluated with policies for the organization actions. One example of a metric is execution time of an organization action performed with an application. Organization actions that take longer to execute may be recognized as organization action incidents.

The system allows the administrator to manage and monitor organization actions in a business oriented manner. Additionally, the administrator may monitor performance, security, and compliance policies at the organization action level rather than at the user or application level to provide finer control over activities of users interacting with applications. The administrator may also ensure security by monitoring users executing the organization actions to determine compliance with security policies. The administrator may implement policies to allocate or manage resources to certain types of organization actions. Further, the administrator may manage compliance of response times for service-level agreements or other rules governing the execution, accounting, and/or reporting of organization actions.

FIG. 2 is a flowchart for managing incidents of organization actions performed with applications in an exemplary implementation of the invention. FIG. 2 begins in step 200. In step 210, the analyzer 160 receives at least one policy for the organization action performed with the application server 130.

A policy is any quota, threshold, or rule used to manage or control a resource, such as file access or CPU time. Some examples of policies are security policies that control security privileges of users and applications, compliance policies that control accounting and reporting of information based on regulatory or statutory laws, and performance policies that control resource tracking, priority, and allocation. A policy may be associated with a specific application and/or a connection to the database server 150 from a particular user.

A policy can also involve more than one organization action, such as a policy applied to an organization scenario. In another example, a policy controls instances of “Analyze Database” organization actions providing that 5 hours must pass between executions of each instance. In yet another example, a policy prevents instances of “Backup Database” organization actions from executing while at least one “Load Database” organization action executes. A policy may also control or manage business level processes or procedures. For example, a policy may generate an alert if a “New Customer Order” organization action includes a product price of $100 when the product is typically sold for $10.

In step 220, the analyzer 160 receives communication messages between an application (e.g., the application server 130) and a server (e.g., the database server 150). The communication messages are the data sent between the application and the server. In one example, the communication messages are packets which include SQL statements. Other examples of communication messages are TCP/IP packets and TTC packets (see FIG. 1).

In step 230, the analyzer 160 processes the communication messages between the application server 130 and the database server 150 to determine the organization action. In step 240, the analyzer 160 determines at least one metric related to the organization action based on the communication messages. A metric is any measurement, statistic, calculation, and/or information related to an organization action performed with an application and a server. Some examples of metrics are execution time of the organization action, types of communication messages (e.g., SQL packets, LDAP messages), packet counts, I/O operations per second, disk space usage, memory usage, and other measurements related to security, performance, and compliance of users, applications, and servers.

In step 250, the analyzer 160 determines whether the metric complies with the policy. In one example, the analyzer 160 compares the execution time of the organization action with an expected execution time and an average execution time established by a policy. In another example, the analyzer 160 retrieves security privileges for users allowed to perform the organization action and matches the security privileges against the user identifier (ID) of the user performing the organization action. In yet another example, the analyzer 160 determines that a user violates a security policy by performing a “User Login” organization action after three unsuccessful attempts. In another example, the analyzer 160 may determine that a “Generate Mailing Label List” organization action by a secretary violates a performance policy controlling resource allocation and priority during a “Generate CEO Report” organization action by the CEO of the organization.

In step 260, if the metric complies with the policy, the flowchart continues to step 280. In step 260, if the analyzer 160 determines that at least one metric does not comply with at least one policy, the analyzer 160 determines that an organization action incident occurred. An organization action incident is an organization or business action that is not executing as expected.

Every organization action that meets one or more incident criteria (i.e., does not comply with at least one metric with at least one policy for organization actions) is flagged or marked as an incident. For example, events, processes, and/or I/O operations occurring in the application or the server or the execution of another organization action may affect the actual execution time of the organization action and cause the execution time to exceed a threshold set by a policy. Other embodiments may manage incidents for a plurality of organization actions, such as a group of business actions or a business scenario.

In step 270, the analyzer 160 performs a task based on the determination whether the metric complies with the policy. A task is any step, method, or action performed in response to an organization action incident. Some examples of tasks are generating a pop-up message for display to the database administrator, generating and sending an email, allocating more or withholding resources, queuing or delaying execution of all or part of the organization action, and canceling execution of the organization action. Continuing the previous performance policy example, the analyzer 160 may instruct the database server 150 to queue or delay the allocation of resources for the “Generate Mailing Label List” organization action until after the “Generate CEO Report” organization action completes. FIG. 2 ends in step 280.

The analyzer 160 allows a database administrator to determine which organization actions execute in an unexpected manner. Additionally, the analyzer 160 can flag for the administrator organization actions that do not execute as expected by a given policy. Moreover, the administrator can quickly relate user reported problems to organization action incidents flagged by the analyzer 160. Furthermore, the analyzer 160 generates a report or log for display to the database administrator allowing identification and resolution of user reported problems from organization actions flagged as incidents.

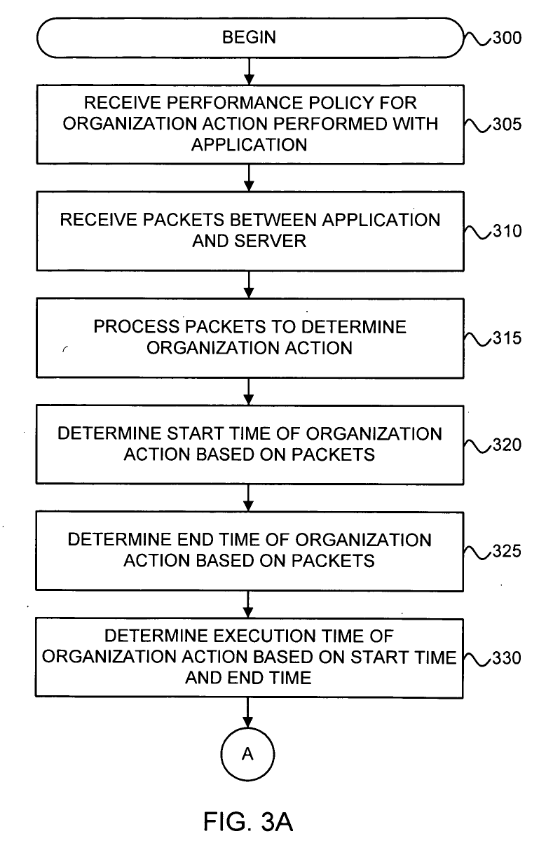

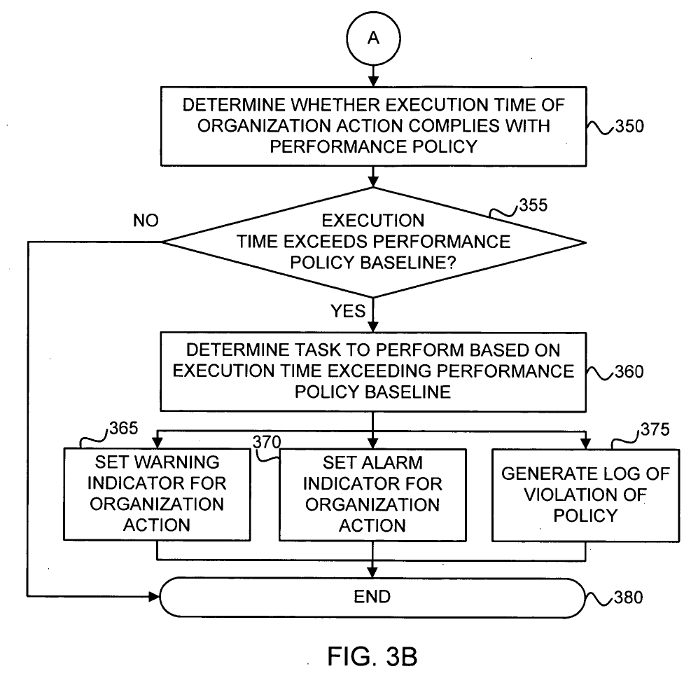

FIGS. 3A and 3B are a flowchart for managing incidents of organization actions performed with applications based on execution time in an exemplary implementation of the invention. FIG. 3A begins in step 300. In step 305, the analyzer 160 receives a performance policy for an organization action performed with an application (e.g., the application server 130). In this example, the performance policy controls a baseline execution time and an average execution time for the organization action. In some embodiments, the baseline is literally the number of seconds established by the database administrator in which the organization action should complete. A simple baseline is independent of any environmental parameters or factors.

In some embodiments, an intelligent baseline execution time may be set dependent to the environment in which the organization action operates. For example, an organization action “Add to Shopping Cart” executing between 5:00 PM -9:00 PM on a working day, not close to a holiday, usually takes 600 milliseconds to complete. The same organization action might take 10-20 seconds to complete if the organization action is executed during the first Monday after Thanksgiving, which can be a busy Internet shopping day.

In one example, the database administrator sets a static threshold for the intelligent baseline. The analyzer 160 then adjusts the intelligent baseline according to the environment in which the organization action executed. For example, an “Update Order Items” organization action will be considered as an incident if the overall execution time is more than 5 seconds between 10:00 AM and 1:00 PM, more than 3 seconds between 1:00 PM and 8:00 PM, and 2 seconds in any other timeframe. In yet another example, the analyzer 160 modifies the intelligent baseline of the policy automatically based on one or more factors. Some factors are the possibility for a violation of the policy for the organization action based on the last X number of violations and the possibility for a violation of the policy based on the last Y minutes.

In some embodiments, the policy includes an alarm level, a warning level, and other definable levels. In further embodiments, the analyzer 160 may have baselines set to a percent over average. The percent over average is calculated using several variables including the number of samples and the execution time of the samples.

In step 310, the analyzer 160 receives packets between an application (e.g., the application server 130) and a server (e.g., the database server 150). In step 315, the analyzer 160 processes the packets between the application server 130 and the database server 150 to determine the organization action. In one example, a packet may contain one or more SQL statements or other communication language. In another example, a SQL statement may comprise multiple packets.

In step 320, the analyzer 160 determines the start time of the organization action based on the packets. For example, the start time may be the earliest timestamp included in the packets. In another example, the start time is the earliest time that the analyzer 160 received the packets that enable the organization action. In step 325, the analyzer 160 determines the end time of the organization action based on the packets. In step 330, the analyzer 160 determines the execution time of the organization action based on the difference between the start time and the end time.

In step 350, the analyzer 160 determines whether the execution time of the organization action complies with the performance policy. In this example, the analyzer 160 compares the actual execution time of the organization action to the policy baseline to determine whether the actual execution time exceeds or is greater than the baseline. The analyzer 160 may also compare the actual execution time of the organization action to the average execution time for the policy to determine which is greater. In some embodiments, the administrator sets the percentage or value in which the actual execution time exceeds the baseline execution time to trigger the alarm mechanism and the warning mechanism. For example, if the actual execution time exceeds the baseline by 10%, the analyzer 160 sets the warning mechanism. If the execution time exceeds the baseline by 25%, the analyzer 160 sets the alarm mechanism.

In step 355, if the actual execution time does not exceed the baseline, FIG. 3B ends in step 380. Alternatively, in step 355, if the actual execution time does exceed the baseline, the analyzer 160 determines a task to perform based on the compliance (or non-compliance in this example) of the execution time with the policy in step 360. For example, in step 365, the analyzer 160 sets a warning indicator for the organization action. In another example, in step 370, the analyzer 160 sets an alarm indicator for the organization action. In yet another example, in step 375, the analyzer 160 generates a log of the violation of the policy by the organization action. FIG. 3B ends in step 380.

Advantageously, the analyzer 160 allows the administrator to compare metrics related to organization actions with policies to quickly locate possible causes, such as database events, that change the execution time of an organization action. Moreover, the analyzer 160 can set warnings and alarms that allow the administrator to quickly locate application and server resources that may degrade future organization action execution and/or performance. Additionally, the administrator can quickly relate user reported problems to flagged organization action incidents to rapidly troubleshoot application and server performance.

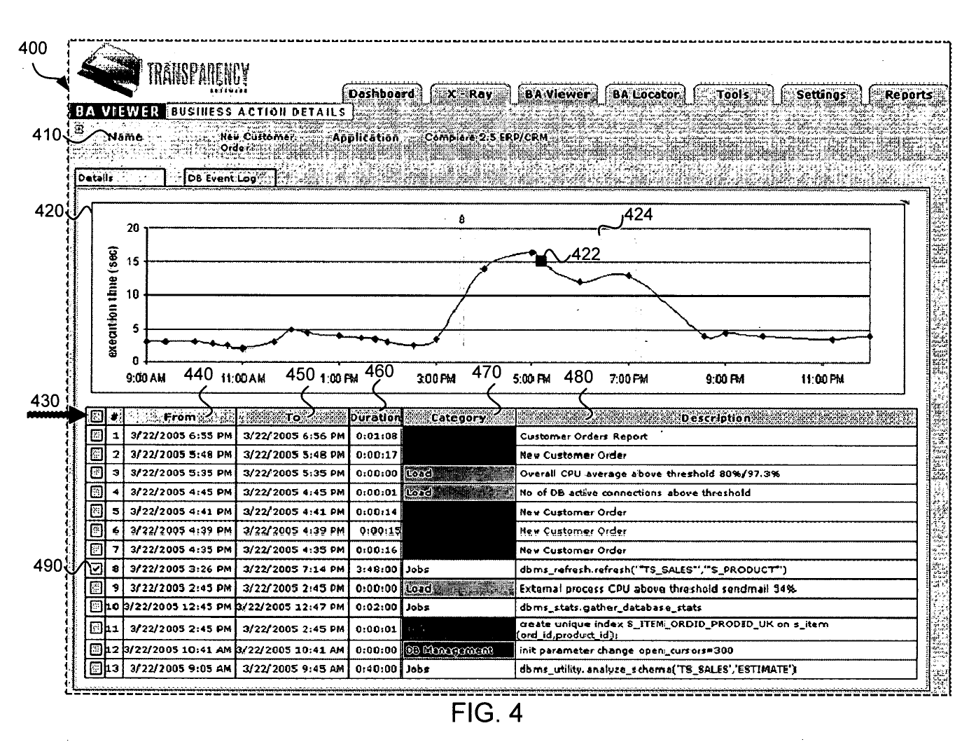

FIG. 4 depicts a screenshot 400 of possible causes for business action incidents in an exemplary implementation of the invention. A possible cause is anything that might have caused an organization action incident. Some examples of possible causes are database events and/or instances of organization action types. Database events are events or results of accessing a database or events that might impact the database performance. Some examples of database events are running jobs in the database, executing a “create index” command, running a backup process, modifying database parameters, power outages, and CPU or memory reallocations. An organization action type is a category or class of organization actions. An organization action instance is an occurrence, execution, or usage of an organization action type.

The screenshot 400 shows a name 410 of a particular business action. In this example, the screenshot 400 displays details for the “New Customer Order” business action. The screenshot 400 includes a chart 420 depicting a graph of execution time over time of many instances of the “New Customer Order” business action. The dots on the graph correspond to the one or more instances of the “New Customer Order” business action. A square 422 depicts a particular instance of the “New Customer Order” business action related to the name 410 around which analyzer 160 determines possible causes. Horizontal and vertical bars 424 represent the timespan where analyzer 160 has checked for possible causes. The start/end times are delineated by the vertical bars 424. Additionally, horizontal and vertical bars 424 are assigned a number, e.g. 8, which corresponds to the database event 490 in the table below the chart.

The screenshot 400 further includes a table 430 depicting start time 440 (“From”), end time 450 (“To”), duration 460, category 470, and description 480 for one or more possible causes related to the instances of the “New Customer Order” business action. The analyzer 160 may assign a color to the category 470 for each business action. For example, the analyzer 160 may color red the category 470 field to signify an organization action incident. The analyzer 160 may use other colors, such as yellow for database “jobs” (e.g., database event 490) and green for database management events. Also, the bars 424 are colored to correspond to the colors of the categories 450.

The screenshot 400 allows the administrator to quickly see possible causes related to business action incidents. The administrator can select the checkbox next to a possible cause to have the analyzer 160 display the bars 424 for the possible cause on the chart 420. In this example, the administrator can see from the chart 420 that the database event 490 possibly caused an increase in the execution time of the particular business action instance (e.g., depicted by the square 422) of the “New Customer Order.” The rise and fall in execution time of business action instances in the chart 420 correspond closely to the duration of the execution time of the database event 490 as depicted by the bars 424.

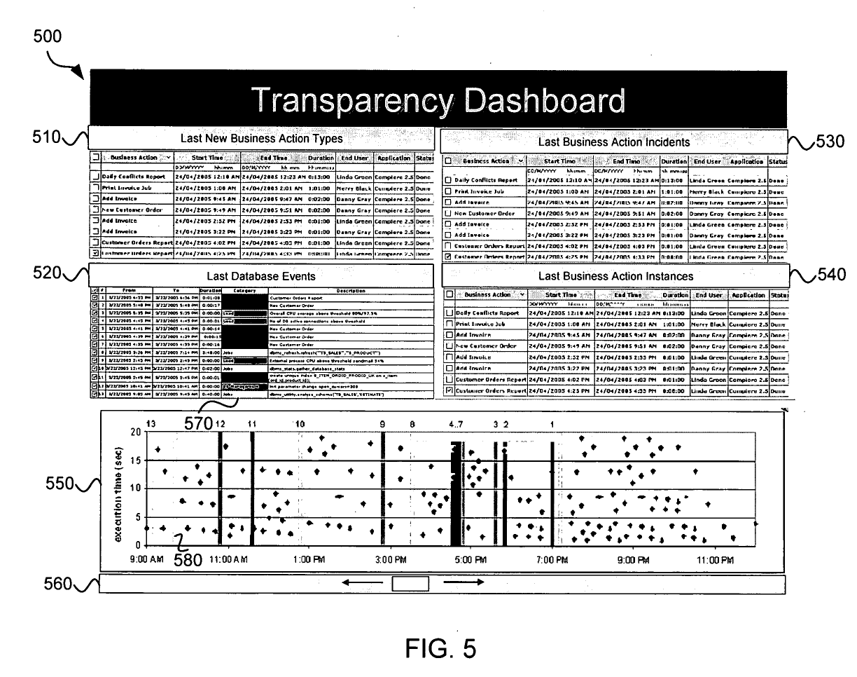

FIG. 5 depicts a screenshot 500 of a dashboard for business actions in an exemplary implementation of the invention. This screenshot 500 of the dashboard provides an “all-in-one” view of the last new business action types 510, the last database events 520, the last business action incidents 530, the last business action instances 540, and a chart 550.

The last new business action types 510 include the columns of business action, start time, end time, duration, end user, application, and status. The last database events 520 include the database event number, the from and to fields for date and time, direction, category, and description of the last database events. The last business action incidents 530 include the business action, start time, end time, duration, end user, application, and status. The last business action instances 540 include the business action, start time, end time, duration, end user, application, and status. The last business action instances 540 are a list of last business actions that have executed.

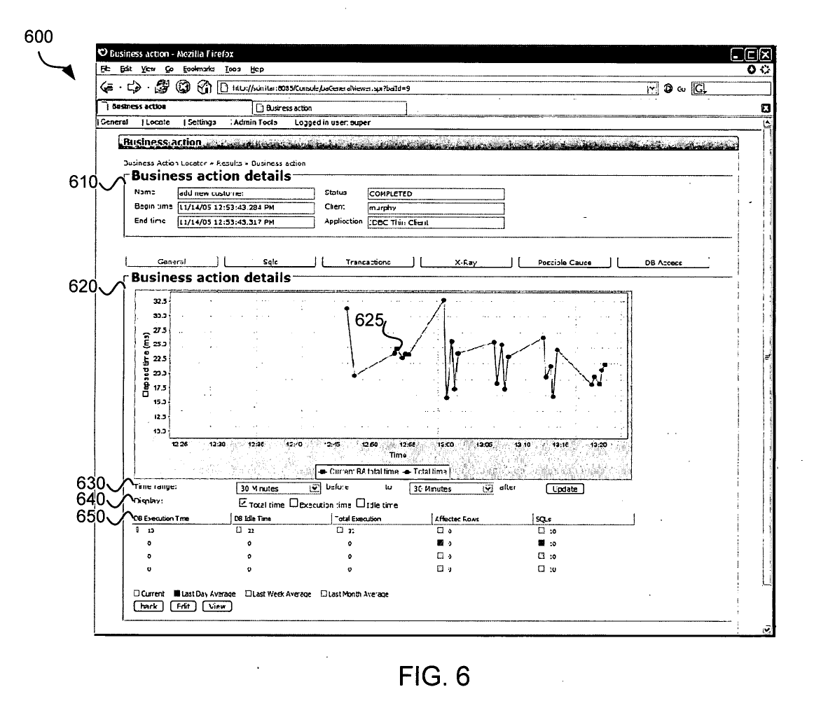

The chart 550 displays a graph of the total response time over time. The dots on the graph correspond to many instances of business actions. Also, the vertical bars 580 are colored to correspond to the categories 570 of the last database events. The slider 560 controls the range of time that is displayed in the above described elements. In some embodiments, the screen shot 500 refreshes periodically such as every few seconds or minutes with the up-to-date information. When the user selects a business action on the screen shot 500, the analyzer 160 displays the details of the business action as depicted in FIG. 6, which is described below.

FIG. 6 depicts a screenshot 600 of business action general details in an exemplary implementation of the invention. The business action details 610 include the name of the business action, the status, begin time, end time, client, and application. A graph 620 shows elapsed time versus time for the current business action time and the total time for a business action instances. The square 625 on the graph 620 represents the total time for the current business action instance, while the dots represent the total time for other business action instances of the business action type. The time range 630 controls the range of the timeline that is displayed in the graph 620. The display boxes 640 control whether the total time, execution time, and/or idle time is shown in the graph 620.

The table 650 shows the DB execution time, DB idle time, total execution time, affected rows and number of SQLs for the current, last day average, last week average, and last month average. The administrator can view the screenshot 600 to determine details related to the execution time of the current business action instance. For example, the administrator can determine whether the business action instance is executing as expected in view of the averages of the other business action instances of the same type.

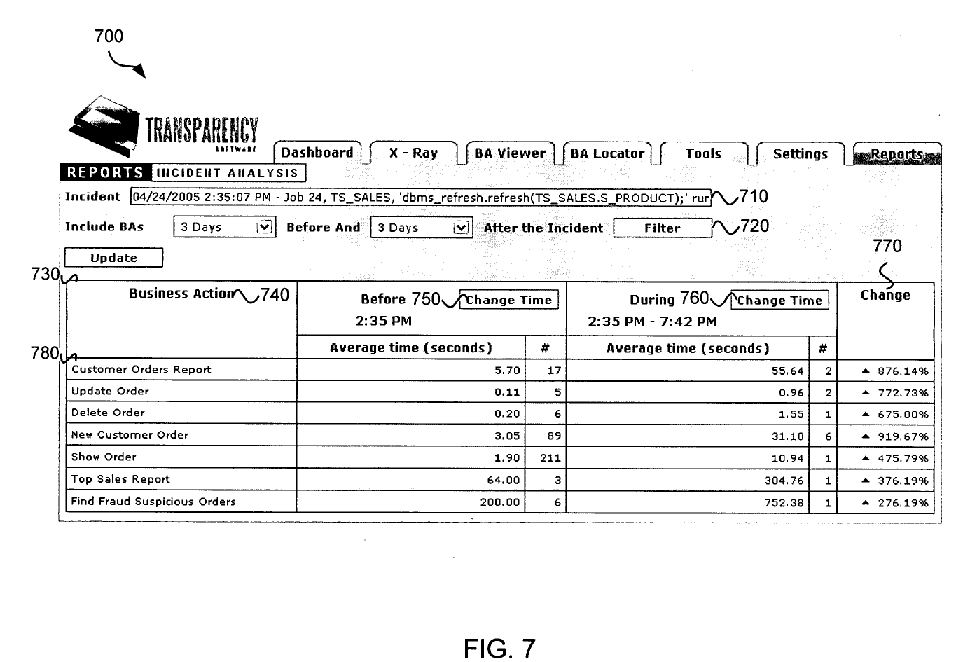

FIG. 7 depicts a screenshot 700 of a database event impact analysis in an exemplary implementation of the invention. The database event impact analysis includes a name 710 of a possible cause, such as the database event 480 (see FIG. 4). The screenshot 700 also includes different combinations of filter criteria 720. The filter criteria 720, X number of days before the business action and Y number of days after the business action, are selected to establish the range of business actions to be used for calculating the averages. In this example, the screenshot 700 depicts a business action filter criteria of 3 days before execution and 3 days after execution. In another example not shown here, the screenshot of a database event impact analysis displays the business action's average times for before, during and after execution.

The screenshot 700 includes a table 730 that depicts one or more business action types 740 that executed during the execution time of the possible cause 710 (i.e., the database event) according to the filter criteria. The table 730 depicts before execution time average 750, during execution time average 760, and change 770 for the one or more business action types 740. The before execution time average 750 includes the average time of instances of the business action types 740 and the number of instances executed before the possible cause 710. The during execution time average 760 includes the average time of the instances of the business action types 740 and the number of instances executed during the possible cause 710.

In this example, the “Customer Orders Report” 780 business action type averaged 5.70 seconds before the execution of the possible cause 710. During execution of the possible cause 710, the “Customers Orders Report” executed for 55.64 seconds, an 876.14% change in execution time. The administrator can quickly see how one or more business action types are affected by the execution of the possible cause. Additionally, the database administrator can determine whether to schedule the execution of the possible cause 710, such as the database job in this example, during off-peak periods of usage for the database server 150.

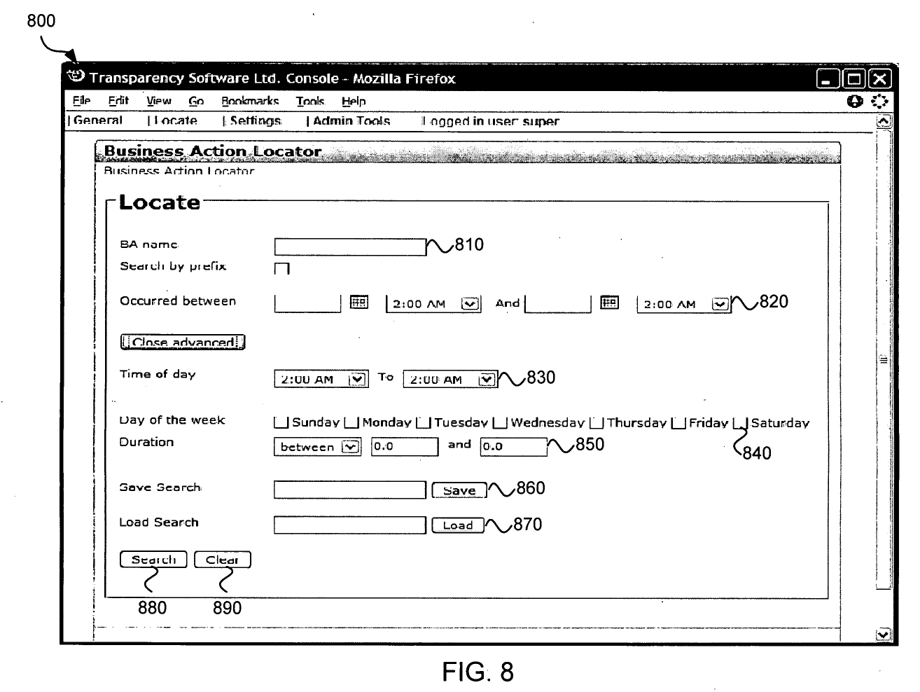

FIG. 8 depicts a screenshot 800 of a business action locator in an exemplary implementation of the invention. The business action locator screenshot 800 includes different types and/or combinations of search criteria to search for a business action. The business action name field 810 allows searching or locating business actions based on a partial or full business action name. A user may also search the business actions based on the from and to dates and times fields 820, the time of day fields 830, the day of the week fields 840, and the duration 850.

After the user enters the search criteria, the user can enter a name and press the save button 860 to save the search criteria. The user may also retrieve a saved search by entering the saved search name and pressing the load button 870.

Once the search criteria are entered in, the user can press the search button 880 to perform the search. The user may also clear the search criteria by pressing the clear button 890. Other search criteria not shown in FIG. 4 may be business action type automatic generated name, incidents at the alarm, warning, or all levels, database schema, business action property (i.e. application), database object accessed, TCP relevant parameters (i.e. client IP and client port), instance values such as bind values or literals in SQL, and other customized properties assigned the user such as groups of business actions.

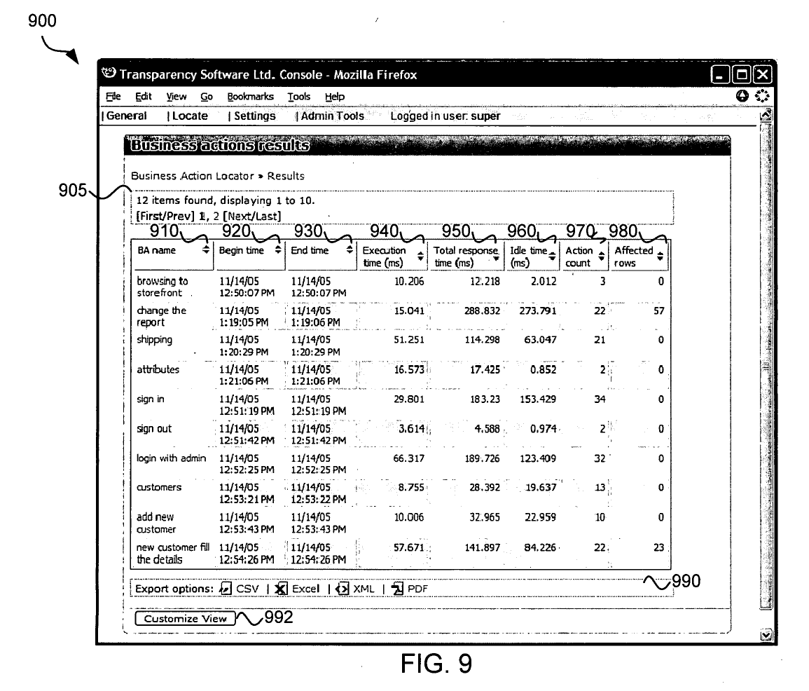

FIG. 9 depicts a screenshot 900 of results of locating business actions in an exemplary implementation of the invention. After the analyzer 160 performs the search of the business actions, the analyzer 160 displays the screenshot 900 of the results of locating a business action. The analyzer 160 displays in the page 905 how many business actions were found and provides controls for moving to different pages of the search results. The results of the business action search include the business action name 910, the begin time 920, the end time 930, the execution time 940, the total response time 950, the idle time 960, the action count 970, and the affected rows 980.

The export options 990 allow the exportation of the search results of the business action to a CSV, Excel, XML, or PDF file. The customize view button 992 allows the users to choose which information of the business action to display and in which order. When the user selects a business action on the screenshot 900, the analyzer 160 displays the details of the business action as depicted in FIG. 6.

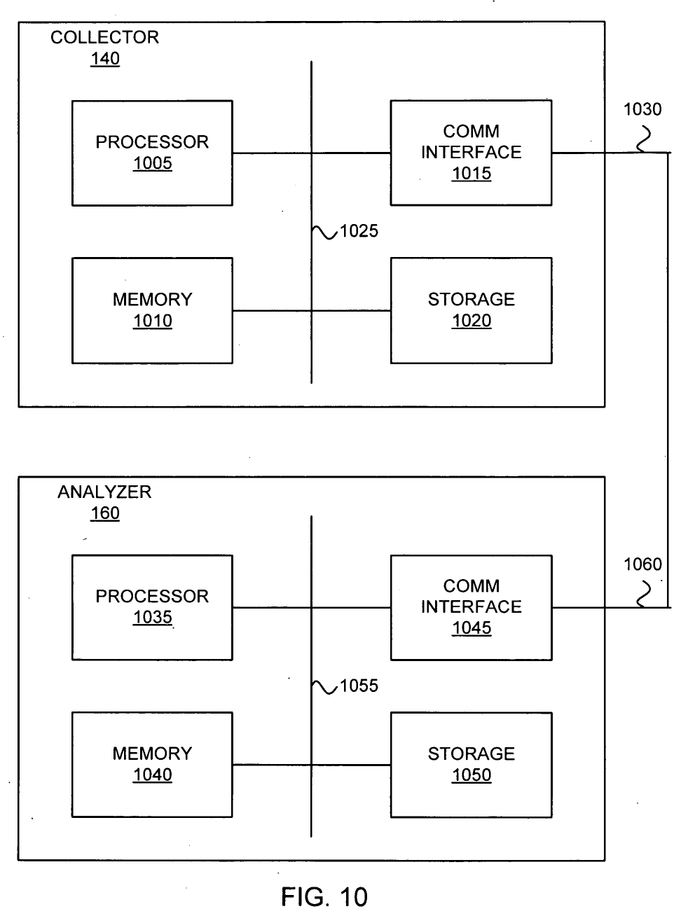

FIG. 10 is a block diagram of the collector 130 and the analyzer 160 in an exemplary implementation of the invention. The collector 130 includes a processor 1005, memory 1010, a communications interface 1015, and storage 1020, which are all coupled to bus 1025. The bus 1025 provides communications between the processor 1005, the memory 1010, the communications interface 1015, and the storage 1020. The analyzer 160 includes a processor 1035, memory 1040, a communications interface 1045, and storage 1050, which are all coupled to bus 1055. The bus 1055 provides communications between the processor 1035, the memory 1040, the communications interface 1045, and the storage 1050.

The processor 1005 and the processor 1035 execute instructions. The memory 1010 and the memory 1040 permanently or temporarily store data. Some examples of the memory 1010 and the memory 1040 are RAM and ROM. The storage 1020 and the storage 1050 also permanently or temporarily store data. Some example of the storage 1020 and the storage 1050 are hard disks and disk drives.

The communications interface 1015 communicates over a communication network (not shown) with the analyzer 160, the application server 100, and the database server 150 via line 1030 (see FIG. 1). The communications interface 1045 communicates over a communication network (not shown) with the collector 130, the database administrator computer 180, and the database server 170 via line 1060 (see FIG. 1).

FIG. 10 depicts one example of how the collector 130 and the analyzer 160 can be configured. There are numerous variations in which the collector 130 and the analyzer 160 can be configured. In one example, the collector 130 and the analyzer 160 can be combined into one device with a processor and a communication interface. In another example, the collector 130 is the communication interface and the analyzer 160 is the processor.

The above-described functions can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for identifying and managing incidents of organization actions performed with applications, the method comprising:
receiving at least one policy for an organization action performed with an application;
processing communication messages between the application and a server to determine the organization action;
determining at least one metric related to the organization action based on the communication messages; and
determining whether the at least one metric does not comply with the at least one policy.

2. The method of claim 1 further comprising performing a task based on the determination whether the at least one metric does not comply with the at least one policy.

3. The method of claim 2 wherein the task comprises setting a warning indicator for the organization action.

4. The method of claim 2 wherein the task comprises generating a log of the determination whether the least one metric does not comply with the at least one policy.

5. The method of claim 1 wherein the at least one policy indicates an expected performance of the organization action with the application and the server.

6. The method of claim 1 wherein the at least one policy indicates security privileges.

7. The method of claim 1 wherein the at least one metric comprises an execution time for the organization action.

8. The method of claim 1 further comprising generating a report for display to an administrator based on the determination whether the at least one metric does not comply with the at least one policy.

9. A system for managing incidents of organization actions performed with applications, the system comprising:
a communications interface configured to receive communication messages between an application and a server; and
a processor configured to receive at least one policy for an organization action performed with the application, process the communication messages between the application and the server to determine the organization action, determine at least one metric related to the organization action based on the communication messages, and determine whether the at least one metric does not comply with the at least one policy.

10. The system of claim 9 wherein the processor is further configured to determine a task to perform based on the determination whether the at least one metric does not comply with the at least one policy.

11. The system of claim 10 wherein the task comprises setting a warning indicator for the organization action.

12. The system of claim 10 wherein the task comprises generating a log of the determination whether the at least one metric does not comply with the at least one policy.

13. The system of claim 9 wherein the at least one policy indicates an expected performance of the organization action with the application and the server.

14. The system of claim 9 wherein the at least one policy indicates security privileges.

15. The system of claim 9 wherein the at least one metric comprises an execution time for the organization action.

16. The system of claim 9 wherein the processor is further configured to generate a report for display to an administrator based on the determination whether the at least one metric does not comply with the at least one policy.

17. A software product for managing incidents of organization actions performed with applications, the software product comprising:
software operational when executed by a processor to direct the processor to receive at least one policy for an organization action performed with an application, process communication messages between the application and a server to determine the organization action, determine at least one metric related to the organization action based on the communication messages, and determine whether the at least one metric does not comply with the at least one policy; and
a software storage medium operational to store the software.

18. The software product of claim 17 wherein the software is operational when executed by the processor to direct the processor to determine a task to perform based on the determination whether the at least one metric does not comply with the at least one policy.

19. The software product of claim 18 wherein the task comprises setting a warning indicator for the organization action.

20. The software product of claim 18 wherein the task comprises generating a log of the determination whether the at least one metric does not comply with the at least one policy.

21. The software product of claim 17 wherein the at least one policy controls performance of the organization action with the application and the server.

22. The software product of claim 17 wherein the at least one policy controls security privileges.

23. The software product of claim 17 wherein the at least one metric comprises an execution time for the organization action.

24. The software product of claim 17 wherein the software is operational when executed by the processor to direct the processor to generate a report for display to an administrator abased on the determination whether the at least one metric does not comply with the at lest on policy.
